(19) United States
(12) Patent Application Publication
(10) Pub. No.: US 2023/0236007 A1
(43) Pub. Date: Jul. 27, 2023

(54) METHOD FOR MEASURING THICKNESS AND OPTICAL CONSTANTS OF DIAMOND FILM

(71) Applicant: Huaqiao University, Quanzhou City (CN)

(72) Inventors: Changcai Cui, Xiamen City (CN); Ziqing Li, Xiamen City (CN); Jing Lu, Xiamen City (CN); Zhongwei Hu, Xiamen City (CN); Xipeng Xu, Xiamen City (CN); Hui Huang, Xiamen City (CN); Guoqin Huang, Xiamen City (CN)

(21) Appl. No.: 18/129,922

(22) Filed: Apr. 3, 2023

Related U.S. Application Data
(63) Continuation of application No. PCT/CN2021/103742, filed on Jun. 30, 2021.

(30) Foreign Application Priority Data
Nov. 18, 2020 (CN) 202011296380.X

(51) Int. Cl. G01B 11/06; G01N 21/31; G01N 21/21

(52) U.S. Cl. CPC G01B 11/0625; G01N 21/31; G01N 21/211; G01N 2021/213

(57) ABSTRACT

First, it is judged whether the diamond film is the single-crystal diamond film or the polycrystalline diamond film according to ellipsometric spectrum data and absorption spectrum data, and different calculation methods are selected to obtain the optical constants and the thickness of the diamond film according to spectral data (e.g., the ellipsometric spectrum data and the absorption spectrum data). Additionally, in the single-crystal diamond film, the optical constants and the thickness of the diamond film are obtained through calculation using the Cauchy model. In the polycrystalline diamond film, the spectral region is selected, and the optical constants and the thickness of the diamond film are obtained through calculation according to the oscillator model and the evaluation function MSE.

### RELATED APPLICATIONS

This application is a continuation of International patent application PCT/CN2021/103742, filed on Jun. 30, 2021, which claims priority to Chinese patent application 202011296380.X, filed Nov. 18, 2020. International patent application PCT/CN2021/103742 and Chinese patent application 202011296380.X are incorporated herein by reference.

### FIELD OF THE DISCLOSURE

The present disclosure relates to the field of optical measurement, and in particular relates to a method for measuring a thickness and optical constants of a diamond film.

### BACKGROUND OF THE DISCLOSURE

The existing method for measuring optical constants of optical films in ultra-wide band, for example, CN06706521A comprises step 1: an optical film with a preset thickness is deposited on a silicon substrate; step 2: an ellipsometric spectrum from ultraviolet to near-infrared band and a transmission spectrum in an infrared band of the deposited optical film are measured; step 3: a spectral region defining a transparent section of the optical film is selected according to the aforementioned spectral data of the optical film, and a refractive index n and a thickness dl of the optical film is obtained through calculation using Cauchy model in the spectral region; step 4: an optical constant model with a wide spectral range for optical constants, from ultraviolet to infrared, is established, and an oscillator model for dielectric constants is added to an absorption spectral section, a center frequency of the oscillator model is an absorption position, and an amplitude and a width of the oscillator are adjusted according to the aforementioned spectral data; step 5: the ellipsometric spectrum from the ultraviolet to the near-infrared band and the transmission spectrum in the infrared band function as a composite target, an inverse operation of the optical constants of the optical film in a full spectrum range from ultraviolet to infrared is performed, wherein an initial value of the thickness is set as dl. An evaluation function is mean square error (MSE) of measured values and calculated values of a theoretical model. The MSE is smaller, and a fitted effect is better; step 6: according to fitted results of the MSE, various parameters of the oscillator model for the dielectric constants are obtained, the optical constants of the optical film in a spectrum range with the ultra-wide band from the ultraviolet to the infrared are then obtained, the optical constants comprises refractive index n, extinction coefficient k, and a physical thickness d of the optical film.

The aforementioned method needs transmittance data in the wider infrared band, and a single-crystal diamond film and a polycrystalline diamond film are not distinguished.

### BRIEF SUMMARY OF THE DISCLOSURE

The present disclosure provides a method for measuring a thickness and optical constants of a diamond film to overcome the deficiencies of the method for measuring optical constants of an optical film in ultra-wide band in the background.

In order to solve the aforementioned technical problem, a technical solution of the present disclosure is as follows:

A method for measuring a thickness and optical constants of a diamond film, comprising:

step 1: depositing a diamond film on a substrate;

step 2: measuring ellipsometric spectrum data and absorption spectrum data of the diamond film;

step 3: judging whether the diamond film is a single-crystal diamond film or a polycrystalline diamond film according to the ellipsometric spectrum data and the absorption spectrum data, executing step 41 when the diamond film is the single-crystal diamond film, and executing steps 42, 5, and 6 when the diamond film is the polycrystalline diamond film;

step 41: obtaining optical constants and a thickness of the single-crystal diamond film through calculation using the Cauchy model in a full spectral region, wherein the optical constants of the single-crystal diamond film at least comprise a refractive index n and an extinction coefficient k;

step 42: selecting a spectral region defining a transparent section for the polycrystalline diamond film from the polycrystalline diamond film, and obtaining optical constants and a thickness d of the polycrystalline diamond film through calculation using the Cauchy model in the spectral region;

step 5: adding an oscillator model for dielectric constants to the absorption spectrum data of the polycrystalline diamond film, and adjusting an amplitude and a width of the oscillator model according to the ellipsometric spectrum data; and

step 6: evaluating a difference between an experimental value and a fitted value by an evaluation function mean square error (MSE) to determine optical constants and the thickness d of the polycrystalline diamond film, wherein the optical constants of the polycrystalline diamond film at least comprise a refractive index n and an extinction coefficient k.

In an embodiment, in the step 3, judging whether the diamond film is the single-crystal diamond film or the polycrystalline diamond film comprises judging whether the diamond film is the single-crystal diamond film or the polycrystalline diamond film according to an absorption difference of the absorption spectrum data.

In an embodiment, in the step 42, a calculation formula of the Cauchy model is:

$$n = An + \frac{Bn}{{λ}^{2}} + \frac{Cn}{{λ}^{4}} \qquad ( 1 )$$

$$k ( λ ) = {A}_{k} {e}^{{B}_{k} ( \begin{matrix}E & {E}_{b}\end{matrix} )} \qquad ( 2 )$$

wherein An, Bn and Cn are parameters of the Cauchy model, λ is wavelength, the extinction coefficient k is described by three parameters Aₖ, Bₖ, and E_{b}, E_{b}=1240/4, and E_{b} relates to a material of the substrate.

In an embodiment, in the step 5, the oscillator model for the dielectric constants is the Lorentz oscillator, and a calculation formula of the Lorentz oscillator is:

$$n = \frac{{AE}_{n}}{{E}_{n}^{2} - {E}^{2} - iBrE} \qquad ( 3 )$$

wherein A is an amplitude of parameters of the oscillator model, En is a center position of the parameters of the oscillator model, and Br is a half wave width of the parameters of the oscillator model.

In an embodiment, in the step 6, a calculation formula of the evaluation function MSE is:

$${MSE}^{2} = \frac{1}{2 N - M} {\sum }_{i - 1}^{n} [ {( \frac{{φ}_{i}^{mod} - {φ}_{i}^{exp}}{{δ}_{φ , i}^{exp}} )}^{2} + {( \frac{{Δ}_{i}^{mod} - {Δ}_{i}^{exp}}{{δ}_{Δ , i}^{exp}} )}^{2} ] \qquad ( 4 )$$

wherein mod is a fitted value, exp is a measured value, δ is a measurement error, N is a total logarithm of ψ and Δ measured by an ellipsometer at the same time, and M is a logarithm of a selected fitted parameter.

In an embodiment, the substrate in the step 1 is a Si substrate, an Al₂O₃ substrate, or a diamond substrate.

Compared with the background of the present disclosure, this technical solution has the following advantages.

First, it is judged whether the diamond film is the single-crystal diamond film or the polycrystalline diamond film according to an ellipsometric spectrum data and absorption spectrum data, and different calculation methods are selected to obtain the optical constants and the thickness of the diamond film according to spectral data (e.g., the ellipsometric spectrum data and the absorption spectrum data). Not only can the refractive index and the thickness of the diamond film be obtained, but the extinction coefficient can also be obtained. Additionally, in the single-crystal diamond film, the optical constants and the thickness of the diamond film are obtained through calculation using the Cauchy model. In the polycrystalline diamond film, the spectral region is selected, and the optical constants and the thickness of the diamond film are obtained through calculation according to the oscillator model and the evaluation function MSE. Therefore, the single-crystal diamond film and the polycrystalline diamond film can be measured, and the thickness and the optical constants, including the refractive index and the extinction coefficient, can be obtained. The measurement accuracy is high, and the measurement time is short.

The calculation formula of the Cauchy model is as follows:

$$n = An + \frac{Bn}{{λ}^{2}} + \frac{Cn}{{λ}^{4}} \qquad ( 1 )$$

$$k ( λ ) = {A}_{k} {e}^{{B}_{k} ( \begin{matrix}E & {E}_{b}\end{matrix} )} \qquad ( 2 )$$

The calculation formula of the Lorentz oscillator is as follows:

$$n = \frac{{AE}_{n}}{{E}_{n}^{2} - {E}^{2} - iBrE} \qquad ( 3 )$$

The calculation formula of the evaluation function MSE is:

$${MSE}^{2} = \frac{1}{2 N - M} {\sum }_{i - 1}^{n} [ {( \frac{{φ}_{i}^{mod} - {φ}_{i}^{exp}}{{δ}_{φ , i}^{exp}} )}^{2} + {( \frac{{Δ}_{i}^{mod} - {Δ}_{i}^{exp}}{{δ}_{Δ , i}^{exp}} )}^{2} ] \qquad ( 4 )$$

A measurement accuracy is high.

### DETAILED DESCRIPTION OF THE EMBODIMENTS

The technical solution of the present disclosure will be further described below in combination with the accompanying embodiments and drawings.

A method for measuring a thickness and optical constants of a diamond film comprises the following steps:

Step 1. A diamond film is deposited on a substrate. For example, the substrate can be a Si substrate, an Al₂O₃ substrate, or a diamond substrate, but the disclosure is not limited thereto. Other substrates can be selected as required;

Step 2. Ellipsometric spectrum data and absorption spectrum data of the diamond film are measured. For example, the ellipsometric spectrum data and the absorption spectrum data are obtained by an ellipsometer;

Step 3. It is judged whether the diamond film is a single-crystal diamond film or a polycrystalline diamond film according to the ellipsometric spectrum data and the absorption spectrum data obtained in step 2. When the diamond film is the single-crystal diamond film, the step 41 is executed, and when the diamond film is the polycrystalline diamond film, the steps 42, 5, and 6 are executed. For example, it is judged whether the diamond film is the single-crystal diamond film or the polycrystalline diamond film according to an absorption difference of the absorption spectrum data, such as according to a variation of absorption coefficient k. When there is no absorption, k is 0, and the diamond film is the single-crystal diamond film. When there is absorption, k is a curve, and the diamond film is the polycrystalline diamond film;

Step 41. The optical constants and the thickness d of the single-crystal diamond film are obtained through a calculation using the Cauchy model in a full spectral region. The optical constants of the single-crystal diamond film at least comprise a refractive index n and an extinction coefficient k;

Step 42. A spectral region defining a transparent section for the polycrystalline diamond film is selected from the polycrystalline diamond film, and the optical constants and a thickness d of the polycrystalline diamond film are obtained through calculation using the Cauchy model in the spectral region;

A calculation formula of the Cauchy model is:

$$n = An + \frac{Bn}{{λ}^{2}} + \frac{Cn}{{λ}^{4}} \qquad ( 1 )$$

$$k ( λ ) = {A}_{k} {e}^{{B}_{k} ( E - {E}_{b} )} \qquad ( 2 )$$

Wherein An, Bn, and Cn are parameters of the Cauchy model, λ is wavelength, an extinction coefficient k is described by three parameters Aₖ, Bₖ, and E_{b}, E_{b}=1240/4, and E_{b} relates to a material of the substrate;

Step 5. An oscillator model for dielectric constants is added to the absorption spectrum data of the polycrystalline diamond film, and an amplitude and a width of the oscillator model of the polycrystalline diamond film are adjusted according to the ellipsometric spectrum data;

The oscillator model for the dielectric constants is the Lorentz oscillator, and a calculation formula of the Lorentz oscillator is as follows:

$$n = \frac{{AE}_{n}}{{E}_{n}^{2} - {E}^{2} - iBrE} \qquad ( 3 )$$

Wherein A is an amplitude of parameters of the oscillator model, En is a center position of the parameters of the oscillator model, and Br is a half wave width of the parameters of the oscillator model.

Step 6. A difference between an experimental value and a fitted value is evaluated using an evaluation function MSE to determine a refractive index n, the extinction coefficient k, the thickness d of the polycrystalline diamond film. A fitted effect is better when the evaluation function MSE is smaller.

A calculation formula of the evaluation function MSE is as follows:

$${MSE}^{2} = \frac{1}{2 N - M} {\sum }_{i = 1}^{n} [ {( \frac{{φ}_{i}^{mod} - {φ}_{i}^{exp}}{{δ}_{φ , i}^{exp}} )}^{2} + {( \frac{{Δ}_{i}^{mod} - {Δ}_{i}^{exp}}{{δ}_{Δ , i}^{exp}} )}^{2} ] \qquad ( 4 )$$

Wherein mod is the fitted value, exp is a measured value, δ is a measurement error, N is a total logarithm of ψ and Δ measured by ellipsometer at the same time, and M is a logarithm of a selected fitted parameter.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A method for measuring a thickness and optical constants of a diamond film, comprising:
step 1: depositing a diamond film on a substrate;
step 2: measuring ellipsometric spectrum data and absorption spectrum data of the diamond film;
step 3: judging whether the diamond film is a single-crystal diamond film or a polycrystalline diamond film according to the ellipsometric spectrum data and the absorption spectrum data, executing step 41 when the diamond film is the single-crystal diamond film, and executing steps 42, 5, and 6 when the diamond film is the polycrystalline diamond film;
step 41: obtaining optical constants and a thickness of the single-crystal diamond film through calculation using Cauchy model in a full spectral region, wherein the optical constants of the single-crystal diamond film at least comprise a refractive index n and an extinction coefficient k;
step 42: selecting a spectral region defining a transparent section for the polycrystalline diamond film from the polycrystalline diamond film, and obtaining optical constants and a thickness d of the polycrystalline diamond film through calculation using the Cauchy model in the spectral region;
step 5: adding an oscillator model for dielectric constants to the absorption spectrum data of the polycrystalline diamond film, and at least adjusting an amplitude and a width of the oscillator model of the polycrystalline diamond film according to the ellipsometric spectrum data; and
step 6: evaluating a difference between an experimental value and a fitted value by an evaluation function mean square error (MSE) to determine the optical constants and the thickness d of the polycrystalline diamond film, wherein the optical constants of the polycrystalline diamond film at least comprise a refractive index n and an extinction coefficient k.

2. The method according to claim 1, wherein in the step 3, judging whether the diamond film is the single-crystal diamond film or the polycrystalline diamond film comprises judging whether the diamond film is the single-crystal diamond film or the polycrystalline diamond film according to an absorption difference of the absorption spectrum data.

3. The method according to claim 1, wherein in the step 42, a calculation formula of the Cauchy model is:
$$n = An + \frac{Bn}{{λ}^{2}} + \frac{Cn}{{λ}^{4}} \qquad ( 1 )$$
$$k ( λ ) = {A}_{k} {e}^{{B}_{k} ( \begin{matrix}E & {E}_{b}\end{matrix} )} \qquad ( 2 )$$
wherein An, Bn and Cn are parameters of the Cauchy model, λ is wavelength, the extinction coefficient k is described by three parameters Aₖ, Bₖ, and E_{b}, E_{b}=1240/4, and E_{b} relates to a material of the substrate.

4. The method according to claim 1, wherein:
in the step 5, the oscillator model for the dielectric constants is Lorentz oscillator, and
a calculation formula of the Lorentz oscillator is:
$$n = \frac{{AE}_{n}}{{E}_{n}^{2} - {E}^{2} - iBrE} \qquad ( 3 )$$
wherein A is an amplitude of parameters of the oscillator model, En is a center position of the parameters of the oscillator model, and Br is a half wave width of the parameters of the oscillator model.

5. The method according to claim 1, wherein:
in the step 6, a calculation formula of the evaluation function MSE is:
$${MSE}^{2} = \frac{1}{2 N - M} {\sum }_{i - 1}^{n} [ {( \frac{{φ}_{i}^{mod} - {φ}_{i}^{exp}}{{δ}_{φ , i}^{exp}} )}^{2} + {( \frac{{Δ}_{i}^{mod} - {Δ}_{i}^{exp}}{{δ}_{Δ , i}^{exp}} )}^{2} ] \qquad ( 4 )$$
wherein mod is a fitted value, exp is a measured value, 6 is a measurement error, N is a total logarithm of ψ and Δ measured by an ellipsometer at the same time, and M is a logarithm of a selected fitted parameter.

6. The method according to claim 1, wherein the substrate in the step 1 is a Si substrate, an Al₂O₃ substrate, or a diamond substrate.
